(19) United States
(12) Patent Application Publication
(10) Pub. No.: US 2005/0228103 A1
(43) Pub. Date: Oct. 13, 2005

(54) Composition comprising intercalated metal-ion sequestrants

(75) Inventors: Joseph F. Bringley, Rochester, NY (US); David L. Patton, Webster, NY (US); Richard W. Wien, Pittsford, NY (US)

Correspondence Address: Paul A. Leipold;Patent Legal Staff, Eastmand Kodak Company, 343 State Street, Rochester, NY, 14650-2201, US

(73) Assignee: Eastman Kodak Company

(21) Appl. No.: 10/822,939

(22) Filed: Apr. 13, 2004

(51) Int. Cl. C08K 3/34

(52) U.S. Cl. 524/445; 252/378 R

(57) ABSTRACT

A composition of matter comprising intercalated composite particles comprising a layered host material intercalated with a metal ion sequestrant having a stability constant greater than 10¹⁵ with iron (III), wherein said sequestrant is not an alpha amino carboxylate. It further relates to articles comprising the composite particles.

### FIELD OF THE INVENTION

The present invention relates to a composition of matter useful for sequestering target metal-ions from a contacting environment, comprising intercalated composite particles having a high-affinity and high-capacity for metal-ions. The invention also relates to articles useful for sequestering target metal-ions from a surrounding environment, and able to prevent microbial contamination.

### BACKGROUND OF THE INVENTION

Numerous materials and methods have been developed for providing antimicrobial properties to medical items, consumer articles and food packaging. Nearly all of the methods thus far developed rely on the release of bacteriocides or bacteriostats to kill unwanted microbes such as bacteria, viruses, yeast, etc. There is a general problem with this approach in that the released chemicals can be harmful to the user of said items, or may leach into aquatic or surrounding environments. Materials and methods which are cleaner and safer are needed to prevent microbial contamination and infectious disease.

Small concentrations of metal-ions may play an important role in biological processes. For example, Mn, Fe, Ca, Zn, Cu and Al are essential bio-metals, and are required for most, if not all, living systems. Metal-ions play a crucial role in oxygen transport in living systems, and regulate the function of genes and replication in many cellular systems. Calcium is an important structural element in the formation of bones and other hard tissues. Mn, Cu and Fe are involved in metabolism and enzymatic processes. At high concentrations, metals may become toxic to living systems and the organism may experience disease or illness if the level cannot be controlled. As a result, the availability and concentrations of metal-ions in biological environments is a major factor in determining the abundance, growth-rate and health of plant, animal and micro-organism populations.

It has been recognized that iron is an essential biological element, and that all living organisms require iron for survival and replication. Although the occurrence and concentration of iron is relatively high on the earth's surface, the availability of “free” iron is severely limited by the extreme insolubility of iron in aqueous environments. As a result, many organisms have developed complex methods of procuring “free” iron for survival and replication. Controlling the concentration of “free” iron in any biological system can, therefore, allow one to control the growth rates and abundance of micro-organisms. Such control can be of great use for treating sickness and disease, inhibiting bacterial growth, treating wounds, and providing for the general health of plant, animal, micro-organism and human populations. Indeed, iron “chelating” or “sequestering” drugs are used to treat iron deficiency in plants; and are used to treat diseases such as Cooley's anemia (thalassemia), sickle-cell anemia, and iron overload diseases in humans.

Metal-ions may also exist as contaminants in environments such as drinking water, beverages, food, industrial effluents and public waste waters, and radioactive waste. Methods and materials for removing such contaminants are important for cleaning the environment(s) and providing for the safety of the general public.

U.S. Pat. No. 5,217,998 to Hedlund et al. describes a method for scavenging free iron or aluminum in fluids such as physiological fluids by providing in such fluids a soluble polymer substrate having a chelator immobilized thereon. A composition is described which comprises a water-soluble conjugate comprising a pharmaceutically acceptable water-soluble polysaccharide covalently bonded to deferoxamine, a known iron chelator. The conjugate is said to be capable of reducing iron concentrations in body fluids in vivo.

U.S. Pat. No. 6,156,334 to Meyer-Ingold et al. describes novel wound coverings that can remove interfering factors (such as iron ions) from the wound fluid of chronic wounds. The wound coverings may comprise iron chelators covalently bonded to a substrate such as cloth or cotton bandages.

U.S. Patent application 2003/0078209 A1 to Schmidt et al. describes solid porous compositions, substantially insoluble in water, comprising at least 25% by weight of an oxidized cellulose and having a significant capacity to bind iron. The invention also describes a method of sequestering dissolved iron from aqueous environments. The compositions may be used for the prevention or treatment of infections by bacteria or yeast.

Tarasov and O'Hare (Inorganic Chemistry, 42, 1919 (2003)) have shown that alpha amino carboxylates such as ethylenediamminetetraacetate (EDTA) may be intercalated into layered double hydoxide to form intercalation complexes. The authors further show that soluble metals such as copper and nickel may be trapped into the solid phase of the intercalation complex. There is a problem, however, in that the alpha amino carboxylate intercalated does not have a sufficiently high affinity for metal-ions, and is not highly-selective for biologically important metal-ions.

Materials are needed that are able to target and selectively remove specific metal-ions, while leaving intact the concentrations of beneficial metal-ions. Furthermore, materials are needed that have a high capacity for metal-ions and that provide the efficient removal of metal-ions in a cost effective manner.

### SUMMARY OF THE INVENTION

This invention provide a composition of matter comprising intercalated composite particles comprising a layered host material intercalated with a metal ion sequestrant having a stability constant greater than 10¹⁵ with iron (III), wherein said sequestrant is not an alpha amino carboxylate. This invention further provides an article containing said intercalated composite particles, capable of sequestering metal-ions from a surrounding environment. The invention further provides an article having as its outer-most layer a barrier layer; and a polymeric layer comprising said intercalated composite particles between the surface of the article and the barrier layer; wherein the barrier layer does not contain the intercalated composite particles and is impenetrable to microbes such as bacteria, viruses and fungi.

The intercalated composite particles used in the invention are able to target and remove specific metal-ions, while leaving intact the concentrations of beneficial metal-ions. Furthermore, they have a very high capacity for metal-ions and provide for the efficient removal of metal-ions in a cost effective manner. They can be utilized in numerous items and articles and they are easy to apply. The intercalated composite particles can be utilized to remove metal-ions which are themselves contaminants, or they can be used to remove metal-ions which are nutrients for biological contaminants. The intercalated composite particles do not release chemicals that can be harmful to humans or that may leach into aquatic or surrounding environments. Such materials and methods are cleaner and safer in preventing microbial contamination and infectious disease. The use of polymer aids in coating an article comprising the intercalated composite particles may further control the availability of the sequestrant to the target metal-ions. The barrier layer may also control the availability of the sequestrant to the target metal-ions and it may prevent the polymeric layer from being contaminated by microbes or other contaminants. The barrier layer may provide several other functions including improving the physical strength and toughness of the article and resistance to scratching, marring, cracking, etc.

### DETAILED DESCRIPTION OF THE INVENTION

The composition of matter of the invention is useful for removing or sequestering target metal-ions from an environment. In many instances, it is necessary to remove metal-ions from environments such as drinking water, food, biological fluids, industrial effluents, public waste water, and radioactive waste. The composition of matter of the present invention may be applied to articles such as filters, sponges, membranes, textiles, fibres, plastics, metals, paper and other materials used in the construction of articles. Articles containing the composition of matter of the invention are placed in contact with the environment in an amount sufficient to bind the target metal-ion(s), and are then removed or separated from the environment, leaving the environment substantially free of the target metal-ion(s). Alternatively, the inventive composition may be used to recover metal-ions such as precious metals, for example gold and silver, from liquid environments.

In a particular application of the invention, the composition of matter may be applied to the surfaces of consumer items such as plastic wraps, papers, cellophane and polymer films, glass and metal containers and other packaging materials, especially food packaging materials. The composition of matter of the invention may also be applied to medical items such as bandages, gauze, cotton and personal hygiene items such as diapers, bandaids, and other items which come into contact with biological and body fluids. The composition of matter of the invention, and articles comprising the composition of matter of the invention are able to remove or sequester metal-ions such as Zn, Cu and Fe which are essential for biological growth, and thus may inhibit the growth of harmful micro-organisms such as bacteria, viruses, and fungi in the environment they contact. The invention “starves” the micro-organisms of minute quantities of essential nutrients and hence limits their growth and reduces the risk due to bacterial, viral and other infectious diseases.

The invention provides a composition of matter comprising intercalated composite particles comprising a layered host material intercalated with a metal ion sequestrant having a stability constant greater than 10¹⁵ with iron (III), wherein said sequestrant is not an alpha amino carboxylate.

Intercalation is a process in which a layered material, referred to as the host, swells or opens to accommodate other molecules or ions, referred to as the guest.
Host+guest→Host(guest)ₓ
Layered compounds capable of sequestering ions and molecules by intercalation have been described in a number of publications. The choice of host material is dependent upon the particular molecule to be intercalated. A layered host material may be chosen which intercalates only cations, or conversely, only anions, or neutral molecules. The choice of layered host materials for practice of the invention can be discerned from reviewing the wide body of literature available on intercalation chemistry and intercalation compounds. The following publications are included for reference on this matter: “Intercalation Chemistry”, A. J. Jacobson and S. Whittingham, eds., Academic Press, NY 1982; “Intercalated Layered Materials”, F. Levy, D. Riedel Press, Dordrecht, Holland (1979); “An Introduction to Clay Colloid Chemistry”, H. van Olphen, 2^{nd} Ed., Krieger Pub. Co., Malabar, Fla. (1991).

Preferred layered host materials for use in the present invention include:
1) Layered metal hydrogen phosphate structures of the formula:
   M(M′PO₄)₂:yH₂O;
   where M is Zr, Ti, Sn, Ge or Hf or any combination thereof; M′ is H, Na, K, Cs, Rb, Ca or Mg, and y is a rational number between 0 and 10.
2) Layered double hydroxides of the general formulas: or
   [M²⁺₁₋ₓM³⁺ₓ(OH)₂]Aⁿ⁻_{x/n}.yH₂O
   or
   [M¹⁺M³⁺₂(OH)₆]Aⁿ⁻_{x/n}.yH₂O;
3) Layered hydroxy double salts of the general formula:
   (M1²⁺,M2²⁺)₅(OH)₈₋(Aⁿ⁻)_{2/n}.yH₂O;
   where M¹⁺ is a monovalent metal, preferably Li, Na, K, Rb or Cs; and M²⁺, M1²⁺ or M2²⁺ are independently a divalent metal, preferably Ca, Mg, Mn, Co, Ni, Cu, Zn, and Cd; and M³⁺ is a trivalent metal, preferably Cr, Fe, Al, Ga, In, Mo; A is an anion chosen from OH⁻, NO₃⁻, F⁻, Cl⁻, Br⁻, I⁻, ClO₄⁻, SO₄²⁻, CO₃²⁻ or any inorganic or organic anion, especially carboxylates and sulfonates chosen such that the rule of charge neutrality is obeyed; n is an integer and x and y may be any rational number between 0 and 1, and between 0 and 10, respectively.
3) Layered siliceous materials (sometimes broadly referred to as “clays”) such as natural or synthetic clay minerals exemplified by montmorillonite, bentonite, kaolin, magadiite, hectorite, vermiculite, smectites, beidellite, fluorohectorite, talc, muscovite and saponite or materials represented by the general formula:
   [M1,M2]ₙZ₄O₁₀(OH)₂._{y}H₂O._{w}M3;
   where M1 is Al, Fe, Mn or Co and M2 is Mg, Fe, Ni, Zn or Li; Z is Al or Si; H₂O is chemically absorbed water and M3 is a cation, preferably K, Na, Li or Ca. n is a number from 0 to 4, y is a number from 0 to 10 and w is a number from 0 to 1.

Intercalation of layered materials creates complex materials consisting of guest molecules or ions captured within the host matrix. The layers of the host solid, typically only a few angstroms thick, exfoliate and swell in direct proportion to the size of the guest molecules. The number of guest molecules captured within the layers is determined by their size and the charge of the guest and the host. The process is reversible such that the guest molecules or ions can later be recovered from the complex system.

As indicated above, the preferred choice of host material is dependent upon the particular metal-ion sequestrant to be intercalated. In order to facilitate intercalation of a desired metal-ion sequestrant into a layered host material it may be necessary to prepare functionalized derivatives of the metal-ion sequestrant such that the compound attains a positive or negative charge. To prepare a cation, this may be typically achieved by derivatizing the metal-ion sequestrant with an onium ion group, e.g., an amine or quaternary amine, or phosphonium ion. To prepare an anion, a carboxylic or sulfonic acid function, or a sulfate group, may be attached to the parent metal-ion sequestrant molecule. The selection of derivatized metal-ion sequestrants will be readily apparent to one skilled in the art.

In a particular embodiment, it is preferred that the layered host material is selected from layered double hydroxides, hydroxy double salts, clays, or metal hydrogen phosphates. It is preferred that the host material has a particle size of less than 1 micron. It is further preferred that the host material has a particle size of less than 0.5 micron. The host layered compound may intercalate, or hold within its layers, a specific amount of guest molecules, dependent upon the size and charge of the guest molecule. The capacity of a particular host material for the guest molecules is often referred to as the exchange capacity of the host material. Generally, a layered host may hold a concentration of guest molecules up to its exchange capacity and no more. Beyond the exchange capacity, additional guest molecules are not held tightly by the host layers. It is preferred that the concentration of metal-ion sequestrant is less than the exchange capacity of the host material. This assures that all of the guest molecules will be immobilized between the layers of the host material.

The intercalated composite particles have a high-affinity for metal-ions and are able to sequester or remove metal-ions from aqueous or biological environments. The ability of the intercalated composites particles to sequester metal-ions is due to the metal-ion sequestrant, which is intercalated between the host layers of the composite particles. It is preferred that said metal-ion sequestrant has a high-affinity for iron, and in particular iron (III). It is preferred that the stability constant of the sequestrant for iron (III) be greater than 10²⁰. It is still further preferred that the metal-ion sequestrant has a stability constant for iron greater than 10³⁰. Preferably said metal-ion sequestrant has a high stability constant for iron, copper, zinc, aluminum or heavy metals. The term heavy metals refers to metals having an atomic weight greater than about 100 g/mol, such as Ag, Au, TI, Pb, Cd, and also lanthanides such as La, Ce, Sm, Eu, and Gd, and radioactive metals such as Th, U and Pu.

A measure of the “affinity” of metal-ion sequestrants for various metal-ions is given by the stability constant (also often referred to as critical stability constants, complex formation constants, equilibrium constants, or formation constants) of that sequestrant for a given metal-ion. Stability constants are discussed at length in “Critical Stability Constants”, A. E. Martell and R. M. Smith, Vols. 1-4, Plenum, N.Y. (1977), “Inorganic Chemistry in Biology and Medicine”, Chapter 17, ACS Symposium Series, Washington, D.C. (1980), and by R. D. Hancock and A. E. Martell, Chem. Rev. vol. 89, p. 1875-1914 (1989). The ability of a specific molecule or ligand to sequester a metal-ion may depend also upon the pH, the concentrations of interfering ions, and the rate of complex formation (kinetics). Generally, however, the greater the stability constant, the greater the binding affinity for that particular metal-ion. Often the stability constants are expressed as the natural logarithm of the stability constant. Herein the stability constant for the reaction of a metal-ion (M) and a sequestrant or ligand (L) is defined as follows:
M+nL⇄MLₙ

where the stability constant is βₙ=[MLₙ]/[M][L]ⁿ, wherein [MLₙ] is the concentration of “complexed” metal-ion, [M] is the concentration of free (uncomplexed) metal-ion and [L] is the concentration of free ligand. The log of the stability constant is log βₙ, and n is the number of ligands which coordinate with the metal. It follows from the above equation that if βₙ is very large, the concentration of “free” metal-ion will be very low. Ligands with a high stability constant (or affinity) generally have a stability constant greater than 10¹⁰ or a log stability constant greater than 10 for the target metal. Preferably the ligands have a stability constant greater than 10¹⁵ for the target metal-ion. Table 1 lists common ligands (or sequestrants) and the natural logarithm of their stability constants (log βₙ) for selected metal-ions.

TABLE 1
Common ligands (or sequestrants) and the natural logarithm of their
stability constants (log βₙ) for selected metal-ions.

| Ligand | Ca | Mg | Cu(II) | Fe(III) | Al | Ag | Zn |
|---|---|---|---|---|---|---|---|
| alpha-amino | | | | | | | |
| carboxylates | | | | | | | |
| EDTA | 10.6 | 8.8 | 18.7 | 25.1 | | 7.2 | 16.4 |
| DTPA | 10.8 | 9.3 | 21.4 | 28.0 | 18.7 | 8.1 | 15.1 |
| CDTA | 13.2 | | 21.9 | 30.0 | | | |
| NTA | | | | 24.3 | | | |
| DPTA | 6.7 | 5.3 | 17.2 | 20.1 | 18.7 | 5.3 | |
| PDTA | 7.3 | | 18.8 | | | | 15.2 |
| citric Acid | 3.50 | 3.37 | 5.9 | 11.5 | 7.98 | 9.9 | |
| salicylic acid | | | | 35.3 | | | |
| Hydroxamates | | | | | | | |
| Desferrioxamine B | | | | 30.6 | | | |
| acetohydroxamic | | | | 28 | | | |
| acid | | | | | | | |
| Catechols | | | | | | | |
| 4,5-dihydroxy- | | | | 37 | | | |
| naphthalene-2,7- | | | | | | | |
| disulfonic acid | | | | | | | |
| MECAMS | | | | 44 | | | |
| 4-LICAMS | | | | 27.4 | | | |
| 3,4-LICAMS | 16.2 | | | 43 | | | |
| 8-hydroxyquinoline | | | | 36.9 | | | |
| disulfocatechol | 5.8 | 6.9 | 14.3 | 20.4 | 16.6 | | |

EDTA is ehtylenediamine tetraacetic acid and salts thereof, DTPA is diethylenetriaminepentaacetic acid and salts thereof, DPTA is Hydroxylpropylenediaminetetraacetic acid and salts thereof, NTA is nitrilotriacetic acid and salts thereof, CDTA is 1,2-cyclohexanediamine tetraacetic acid and salts thereof, PDTA is propylenediammine tetraacetic acid and salts thereof. Desferrioxamine B is a commercially available iron chelating drug, desferal®. MECAMS, 4-LICAMS and 3,4-LICAMS are described by Raymond et al. in “Inorganic Chemistry in Biology and Medicine”, Chapter 18, ACS Symposium Series, Washington, D.C. (1980). Log stability constants are from “Critical Stability Constants”, A. E. Martell and R. M. Smith, Vols. 1-4, Plenum Press, NY (1977); “Inorganic Chemistry in Biology and Medicine”, Chapter 17, ACS Symposium Series, Washington, D.C. (1980); R. D. Hancock and A. E. Martell, Chem. Rev. vol. 89, p. 1875-1914 (1989) and “Stability Constants of Metal-ion Complexes”, The Chemical Society, London, 1964.

In many instances, a disease may be associated with a particular metal-ion, either due to a deficiency of this metal-ion, or due to an overload (overdose) of this metal-ion. In such cases it may be desirable to synthesize an intercalated composite particle with a very high specificity or selectivity for a given metal-ion. Intercalated composite particles of this nature may be used to control the concentration of the target metal-ion and thus treat the disease or illness associated with this metal-ion. One skilled in the art may prepare such intercalated composite particles by selecting a metal-ion sequestrant having a high specificity for the target metal-ion. The specificity of a metal-ion sequestrant for a target metal-ion is given by the difference between the log of the stability constant for the target metal-ion, and the log of the stability constant for the interfering metal-ions. For example, if a treatment required the removal of Fe(III), but it was necessary to leave the Ca-concentration unaltered, then from Table 1, 3,4-LICAMS would be a suitable choice since the difference between the log stability constants 43-16.2=26.8, is the largest in Table 1.

It is preferred that the intercalated composite particles have a high stability constant for the target metal-ion(s). It is also preferred that the intercalated composite particles have a high-affinity for biologically significant metal-ions, such as, Zn, Cu, Mn and Fe. The stability constant for the intercalated composite particles will largely be determined by the stability constant for the intercalated metal-ion sequestrant. However, The stability constant for the intercalated composite particles may vary somewhat from that of the intercalated metal-ion sequestrant. Generally, it is anticipated that metal-ion sequestrants with high stability constants will give intercalated composite particles with high stability constants. For a particular application, it may be desirable to have intercalated composite particles with a high selectivity for a particular metal-ion. In most cases, the intercalated composite particles will have a high selectivity for a particular metal-ion if the stability constant for that metal-ion is about 10⁶ greater than for other ions present in the system.

Metal-ion sequestrants may be chosen from various organic molecules. Such molecules having the ability to form complexes with metal-ions are often referred to as “chelators”, “complexing agents”, and “ligands”. Certain types of organic functional groups are known to be strong “chelators” or sequestrants of metal-ions. It is preferred that the sequestrants of the invention contain catechol or hydroxamte functional groups. These are preferred because their stability constants are typically significantly greater than for other chelators, such as alpha amino carboxylates. These are also preferred because they are able to sequester iron (III) very effectively and have a very high selectivity for iron (III). They are yet further preferred because they are effective at sequestering metal-ions over a very broad range of pH conditions.

Hydroxamates (or often called hydroxamic acids) have the general formula: 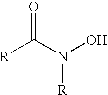
where R is an organic group such as an alkyl or aryl group. Examples of metal-ion sequestrants containing hydroxamate functional groups include acetohydroxamic acid, and desferroxamine B, the iron chelating drug desferal.

Catechols have the general formula: 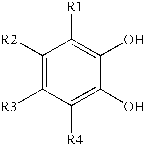
Where R¹, R², R³ and R⁴ may be H, an organic group such as an alkyl or aryl group, or a carboxylate or sulfonate group. Examples of metal-ion sequestrants containing catechol functional groups include catechol, disulfocatechol, dimethyl-2,3-dihydroxybenzamide, mesitylene catecholamide (MECAM) and derivatives thereof, 1,8-dihydroxynaphthalene-3,6-sulfonic acid, and 2,3-dihydroxynaphthalene-6-sulfonic acid.

In a preferred embodiment the intercalated metal-ion sequestrant comprises a siderophore. Siderophores are natural metal-ion sequestrants that are synthesized by micro-organisms for the purpose of procuring free iron for the cell. Micro-organisms produce siderophores in response to iron depleteion or deficiency. Siderophores, such as desferroxamine B, are preferred because they may have very high affinites for iron (III). Siderophores (natural and synthetic) are described at length in “CRC Handbook of Microbial Iron Chelates”, Winkelmann ed., CRC Press (1991).

Preferred metal-ion sequestrants are acetohydroxamic acid, desferroxamine B, dihydroxamic acid, salicylic acid, catechol, disulfocatechol, dimethyl-2,3-dihydroxybenzamide, 5-sulfo-2,3-dihydroxydimethylbenzamide, mesitylene catecholamide (MECAM) and derivatives thereof, LICAMS and derivatives thereof, 4,5-dihydroxynaphthalene-2,7-disulfonic acid (sometimes called 1,8-dihydroxy naphthalene 3,6 sulfonic acid), and 2,3-dihydroxynaphthalene-6-sulfonic acid.

The intercalated composite particles of the present invention may be prepared by general chemical synthetic methods. The solid layered host material is suspended in a suitable solvent, such as water, methanol, ethanol, acetone or other organic solvent. It is preferred that the solvent is chosen such that the guest molecules are soluble in the solvent used. The guest (metal-ion sequestrant) is then stirred in the reaction mixture usually at a temperature between about 25-100° C. for a time of between about 1 hour to 24 hours. The intercalated composite particles may then be recovered by common means of filtration and washed to remove the excess or un-intercalated guest molecules (metal-ion sequestrant).

In a preferred embodiment the composition of matter of the invention further comprises a polymer. The polymer may serve as a binder or as a glue to attach the intercalated composite particles to the surfaces of articles such as plastic wraps, papers, cellophane and polymer films, glass and metal containers and other packaging materials, especially food packaging materials. The composition of matter of the invention may also be applied to medical items such as bandages, gauze, cotton and personal hygiene items such as diapers, bandaids, and other items which come into contact with biological and body fluids. Preferred polymers are selected from one or more of polyvinyl alcohol, cellophane, water-based polyurethanes, polyester, nylon, high nitrile resins, polyethylene-polyvinyl alcohol copolymer, polystyrene, ethyl cellulose, cellulose acetate, cellulose nitrate, aqueous latexes, polyacrylic acid, polystyrene sulfonate, polyamide, polymethacrylate, polyethylene terephthalate, polystyrene, polyethylene and polypropylene or polyacrylonitrile or copolymers thereof.

The invention also provides an article comprising immobilized intercalated composite particles (as described in detail above), comprising a layered host material intercalated with a metal ion sequestrant having a stability constant greater than 10¹⁵ with iron (III), wherein said sequestrant is not an alpha amino carboxylate. In one embodiment the intercalated composite particles are incorporated into the materials forming the article. In another embodiment the intercalated composite particles are contained in a polymeric layer, said layer being located on the surface of the article. This is preferred because it provides the maximum contact between the polymeric layer and the surrounding environment. It is preferred that the polymeric layer is permeable to liquid media, and it is further preferred that the polymeric layer is permeable to aqueous media. This is preferred because permeability facilitates the contact of the contaminant metal-ions with the immobilized intercalated composite particles, which, in turn, facilitates the sequestration of the metal-ions at the particle surfaces. A measure of the permeability of various polymeric addenda to water is given by the permeability coefficient, P which is given by
P=(quantity of permeate)(film thickness)/[area×time×(pressure drop across the film)]
Permeability coefficients and diffusion data of water for various polymers are discussed by J. Comyn, in Polymer Permeability, Elsevier, N.Y., 1985 and in “Permeability and Other Film Properties Of Plastics and Elastomers”, Plastics Design Library, NY, 1995. The higher the permeability coefficient, the greater the water permeability of the polymeric media. The permeability coefficient of a particular polymer may vary depending upon the density, crystallinity, molecular weight, degree of cross-linking, and the presence of addenda such as coating-aids, plasticizers, etc. It is preferred that the polymer has a water permeability of greater than 1000 [(cm³ cm)/(cm²sec/Pa)]×10¹³. Preferred polymers for practice of the invention are one or more of polyvinyl alcohol, cellophane, water-based polyurethanes, polyester, nylon, high nitrile resins, polyethylene-polyvinyl alcohol copolymer, polystyrene, ethyl cellulose, cellulose acetate, cellulose nitrate, aqueous latexes, polyacrylic acid, polystyrene sulfonate, polyamide, polymethacrylate, polyethylene terephthalate, polystyrene, polyethylene, polypropylene or polyacrylonitrile or copolymers thereof.

A support may be provided between the article and the polymeric layer. In this manner the composition of matter of the invention may be applied to the surfaces of a support by methods such as blade coating, dip coating, curtain and rod coating. The polymeric layer may also be applied by painting, spraying, casting, molding, blowing, extruding, etc. Supports suitable for practice of the invention are papers such as resin-coated paper, plain paper, coated paper, synthetic paper, melt-extrusion-coated paper, laminated paper, and polymeric supports such as cellulose derivatives, polyesters, polyethylene, polypropylene, mylar and poly ethylene terephthalate (PET).

In a preferred embodiment, the article of the invention further comprises a barrier layer; wherein the polymeric layer is between the surface of the article and the barrier layer and wherein the barrier layer does not contain the intercalated composite particles. The barrier layer may provide several functions including improving the physical strength and toughness of the article and resistance to scratching, marring, cracking, etc. However, the primary purpose of the barrier layer is to provide a barrier through which micro-organisms cannot pass. It is important to limit, or eliminate, the direct contact of micro-organisms with the surfaces of the intercalated composite particles, since many micro-organisms, under conditions of iron deficiency, may bio-synthesize molecules which are strong chelators for iron, and other metals. These bio-synthetic molecules are called “siderophores” and their primary purpose is to procure iron for the micro-organisms. Thus, if the microorganism are allowed to directly contact the intercalated composite particles of the invention, they may find a rich source of iron there, and begin to colonize directly at these surfaces. The siderophores produced by the micro-organisms may compete with the intercalated composite particles for the iron (or other bio-essential metal) at their surfaces. The barrier layer of the invention does not contain intercalated composite particles, and because micro-organisms are large, they may not pass or diffuse through the barrier layer. The barrier layer thus prevents contact of the micro-organisms with the polymeric layer containing the immobilized intercalated composite particles of the invention.

It is preferred that the barrier layer is permeable to liquid media. This is preferred because metal-ions in solution may then readily diffuse through the barrier layer and become sequestered in the underlying polymeric layer containing the intercalated composite particles. Thus, the barrier layer spatially separates the micro-organisms from the polymeric sequestration layer. It is further preferred that the barrier layer is permeable to aqueous media. It is preferred that the polymer(s) of the barrier layer has a water permeability of greater than 1000 [(cm³ cm)/(cm²sec/Pa)]×1013. Preferred polymers for use in the barrier layer are one or more of polyvinyl alcohol, cellophane, water-based polyurethanes, polyester, nylon, high nitrile resins, polyethylene-polyvinyl alcohol copolymer, polystyrene, ethyl cellulose, cellulose acetate, cellulose nitrate, aqueous latexes, polyacrylic acid, polystyrene sulfonate, polyamide, polymethacrylate, polyethylene terephthalate, polystyrene, polyethylene, polypropylene, or polyacrylonitrile or copolymers thereof. It is preferred that the barrier layer has a thickness in the range of 0.1 microns to 10.0 microns.

The invention also provides a method of removing target metal-ion(s) from an environment comprising contacting the environment with a composition comprising intercalated composite particles comprising a layered host material intercalated with a metal-ion sequestrant having a stability constant greater than 10¹⁵ with iron (III), wherein said sequestrant is not an alpha amino carboxylate. The term “environment” refers to environments that articles or items comprising the inventive composition may come in contact with, and include aqueous and non-aqueous environments containing metal-ion contaminants. Aqueous environments contemplated as applicable to the invention include water, waste water, industrial effluents and radioactive waste, and consumable environments such as drinking water, beverages and food, consumer household environments such as cosmetics, shampoos, tooth paste, etc. Typical environments encountered also include biological and body, fluids. The target metal-ion concentration in the contacting environment should be reduced to as low as possible.

The following examples are intended to illustrate, but not to limit the invention.

### EXAMPLES

Preparation of Intercalated Composite Particles:

Acetohydroxamic acid, benzohydroxamic acid and 4,5-dihydroxynaphthalene-2,7-disulfonic, disodium salt were purchased from Aldrich Chemical Company. Mg_{0.7}Al_{0.3}(OH)₂.0.15 CO₃ (HYCITE 713) was obtained from Sud-Chemie Co. and was pre-treated as follows: 50.00 g of the white powder was heated in air at 500° C. for 3 hours and cooled to room temperature, to prepare an amorphous oxide precursor.

(A) Mg_{0.7}Al_{0.3}(OH)₂.acetohydroxamate.nH₂O: 4.00 g acetohydroxamic acid was placed in 100 ml of distilled water and to the stirred solution under nitrogen was added 31.1 g of calcined HYCITE 713. After 1 hour the pH was adjusted to 6.0 by the dropwise addition of 93.0 mLs of 6 N nitric acid. The mixture was then stirred at 50° C. for 18 hours. The product was collected by vacuum filtration and washed with distilled water. Powder X-ray diffraction indicated an increase in the interlayer lattice spacing of 2.4 Å, the increase in interlayer spacing is indicative of the insertion of molecules between the host layers.

(B) Mg_{0.7}Al_{0.3}(OH)₂.benzohydroxamate.nH₂O: 4.00 g benzohydroxamic acid was placed in 100 ml of distilled water and to the stirred solution under nitrogen was added 17.3 g of calcined HYCITE 713. After 1 hour the pH was adjusted to 6.5 by the dropwise addition of 26.0 mLs of 6 N nitric acid. The mixture was then stirred at 50° C. for 18 hours. The product was collected by vacuum filtration and washed with distilled water. Powder X-ray diffraction indicated an increase in the interlayer lattice spacing of 4.5 Å, the increase in interlayer spacing is indicative of the insertion of molecules between the host layers.

(C) Mg_{0.7}Al_{0.3}(OH)₂.4,5-dihydroxynaphthalene-2,7-disulfonate.nH₂O: 4.00 g 4,5-dihydroxynaphthalene-2,7-disulfonic, disodium salt was placed in 100 ml of distilled water and to the stirred solution under nitrogen was added 11.7 g of calcined HYCITE 713. After 1 hour the pH was adjusted to 6.1 by the dropwise addition of 48.0 mLs of 6 N nitric acid. The mixture was then stirred at 50° C. for 18 hours. The product was collected by vacuum filtration and washed with distilled water. Powder X-ray diffraction indicated an increase in the interlayer lattice spacing of 7.4 Å, the increase in interlayer spacing is indicative of the insertion of molecules between the host layers.

Preparation of Polymeric Layers of Intercalated Composite Particles.

Coating 1. A coating solution was prepared as follows: 7.1 grams of Mg_{0.7}Al_{0.3}(OH)₂.acetohydroxamate.nH₂O prepared as described above was combined with to 74.7 grams of pure distilled water and 17.1 g of a 40% solution of the polyurethane Permax 220 (Noveon Chemicals). 0.5 g of a 10% solution of the surfactant OLIN 10 G was added as a coating aid. The mixture was then stirred and blade-coated onto a polymeric support using a 150 micron doctor blade. The coating was then dried at 40-50° C., to produce a film having 10.8 g/m² of intercalated composite particles (A) and 5.4 g/m² of polyurethane.

Coating 2. A coating solution was prepared as follows: 7.1 grams of Mg_{0.7}Al_{0.3}(OH)₂.benzohydroxamate.nH₂O prepared as described above was combined with to 74.7 grams of pure distilled water and 17.1 g of a 40% solution of the polyurethane Permax 220 (Noveon Chemicals). 0.5 g of a 10% solution of the surfactant OLIN 10 G was added as a coating aid. The mixture was then stirred and blade-coated onto a polymeric support using a 150 micron doctor blade. The coating was then dried at 40-50° C., to produce a film having 10.8 g/m² of intercalated composite particles (B) and 5.4 g/m² of polyurethane.

Coating 3. A coating solution was prepared as follows: 7.1 grams of Mg_{0.7}Al_{0.3}(OH)₂.4,5-dihydroxynaphthalene-2,7-disulfonate nH₂O prepared as described above was combined with to 74.7 grams of pure distilled water and 17.1 g of a 40% solution of the polyurethane Permax 220 (Noveon Chemicals). 0.5 g of a 10% solution of the surfactant OLIN 10 G was added as a coating aid. The mixture was then stirred and blade-coated onto a polymeric support using a 150 micron doctor blade. The coating was then dried at 40-50° C., to produce a film having 10.8 g/m² of intercalated composite particles (C) and 5.4 g/m² of polyurethane.

Sequestration of Iron from an Aqueous Environment.

Samples (1-3) and Comparison Sample C-1

An iron-rich aqueous solution was prepared as follows: 2.0 ml of a 500 ppm solution of Fe³⁺ were carefully dissolved in 98.0 ml of pure distilled water to produce a solution having 10 ppm iron. 5 cm×5 cm pieces of the coatings prepared as described above were then contacted with 25.0 ml of the model biological liquid medium. The pieces of the coatings were left in contact with the medium for the time indicated in Table 2, and a 1.0 ml aliquot of the medium was taken for Fe analysis via inductively coupled plasma-atomic emission spectroscopy. A Comparison sample was prepared using a 5 cm×5 cm piece of the polymeric support which did not contain a coating of the inventive composition. The data are given in Table 2.

TABLE 2

| Sample or | | Concentration |
|---|---|---|
| Comparison | | (ppm) Fe |
| Sample | coating | after 3d |
| 1 | 1 | 1.7 |
| 2 | 2 | 1.9 |
| 3 | 3 | 0.5 |
| C-1 | support only | 7.8 |

The data of Table 2 indicate that the inventive coatings are able to sequester iron from an aqueous medium. The comparison example shows very little reduction of iron concentration after three days exposure. In some cases as much as 95% of the free iron is removed from the aqueous medium, and the level of iron contamination is reduced to as low as 0.5 ppm.

The invention has been described in detail with particular reference to the preferred embodiments thereof, but it will be understood that variations and modifications can be effected within the scope of the invention.

The invention has been described in detail with particular reference to certain preferred embodiments thereof, but it will be understood that variations and modifications can be effected within the spirit and scope of the invention.

1. A composition of matter comprising intercalated composite particles comprising a layered host material intercalated with a metal ion sequestrant having a stability constant greater than 10¹⁵ with iron (III), wherein said sequestrant is not an alpha amino carboxylate.

2. The composition of claim 1 wherein the metal ion sequestrant has a stability constant greater than 10²⁰ with iron (III).

3. The composition of claim 1 wherein the metal ion sequestrant has a stability constant greater than 10³⁰ with iron (III).

4. The composition of claim 1 wherein said metal-ion sequestrant has a high stability constant for copper, zinc, aluminum or heavy metals.

5. The composition of claim 1 wherein the metal ion sequestrant comprises a hydroxamate functional group or a catechol functional group.

6. The composition of claim 1 wherein the metal ion sequestrant comprises a siderophore.

7. The composition of claim 1 wherein the metal ion sequestrant is acetohydroxamic acid, desferroxamine B, dihydroxamic acid, salicylic acid, catechol, disulfocatechol, dimethyl-2,3-dihydroxybenzamide, 5-sulfo-2,3-dihydroxydimethylbenzamide, mesitylene catecholamide (MECAM) and derivatives thereof, LICAMS and derivatives thereof, 4,5-dihydroxynaphthalene-2,7-disulfonic acid, and 2,3-dihydroxynaphthalene-6-sulfonic acid.

8. The composition of claim 1 wherein the host material is layered double hydroxides, hydroxy double salts, clays, or metal hydrogen phosphates.

9. The composition of claim 1 wherein the host material has a particle size of less than 1 micron.

10. The composition of claim 1 wherein the host material has a particle size of less than 0.5 micron.

11. The composition of claim 1 wherein the concentration of metal ion sequestrant is less than the exchange capacity of the host material.

12. The composition of claim 1 further comprising a polymer.

13. The composition of claim 12 wherein the polymer comprises one or more of polyvinyl alcohol, cellophane, water-based polyurethanes, polyester, nylon, high nitrile resins, polyethylene-polyvinyl alcohol copolymer, polystyrene, ethyl cellulose, cellulose acetate, cellulose nitrate, aqueous latexes, polyacrylic acid, polystyrene sulfonate, polyamide, polymethacrylate, polyethylene terephthalate, polystyrene, polyethylene and polypropylene or polyacrylonitrile or copolymers thereof.

14. An article comprising immobilized intercalated composite particles comprising a layered host material intercalated with a metal ion sequestrant having a stability constant greater than 10¹⁵ with iron (III), wherein said sequestrant is not an alpha amino carboxylate.

15. The article of claim 14 wherein the intercalated composite particles are contained in a polymeric layer.

16. The article of claim 14 wherein the intercalated composite particles are incorporated into the materials forming the article.

17. The article of claim 14 wherein the metal ion sequestrant has a stability constant greater than 10²⁰ with iron (III).

18. The article of claim 14 wherein said metal-ion sequestrant has a high stability constant for copper, zinc, aluminum or heavy metals.

19. The article of claim 14 wherein the metal ion sequestrant comprises a hydroxamate functional group or a catechol functional group.

20. The article of claim 14 wherein the metal ion sequestrant is acetohydroxamic acid, desferroxamine B, dihydroxamic acid, salicylic acid, catechol, disulfocatechol, dimethyl-2,3-dihydroxybenzamide, 5-sulfo-2,3-dihydroxydimethylbenzamide, mesitylene catecholamide (MECAM) and derivatives thereof, LICAMS and derivatives thereof, 4,5-dihydroxynaphthalene-2,7-disulfonic acid, and 2,3-dihydroxynaphthalene-6-sulfonic acid.

21. The article of claim 14 wherein the host material is layered double hydroxides, hydroxy double salts, clays, or metal hydrogen phosphates.

22. The article of claim 14 wherein the host material has a particle size of less than 1 micron.

23. The article of claim 15 wherein the polymeric layer is located on the surface(s) of the article.

24. The article of claim 23 wherein the polymeric layer is permeable to liquid media.

25. The article of claim 23 wherein the polymeric layer is permeable to aqueous media.

26. The article of claim 25 wherein the polymeric layer has a water permeability of greater than 1000 [(cm³ cm)/(cm²sec/Pa)]×10¹³.

27. The article of claim 15 wherein the polymeric layer comprises one or more of polyvinyl alcohol, cellophane, water-based polyurethanes, polyester, nylon, high nitrile resins, polyethylene-polyvinyl alcohol copolymer, polystyrene, ethyl cellulose, cellulose acetate, cellulose nitrate, aqueous latexes, polyacrylic acid, polystyrene sulfonate, polyamide, polymethacrylate, polyethylene terephthalate, polystyrene, polyethylene, polypropylene or polyacrylonitrile, or copolymers thereof.

28. The article of claim 14 further comprising a barrier layer; wherein the polymeric layer is between the surface of the article and the barrier layer and wherein the barrier layer does not contain intercalated composite particles.

29. The article of claim 28 wherein the barrier layer is permeable to liquid media.

30. The article of claim 28 wherein the barrier layer is permeable to aqueous media.

31. The article of claim 30 wherein the barrier layer has a water permeability of greater than 1000 [(cm³ cm)/(cm²sec/Pa)]×10¹³.

32. The article of claim 28 wherein the barrier layer has a thickness in the range of 0.1 microns to 10 microns.

33. The article of claim 28 wherein the barrier layer comprises one or more of polyvinyl alcohol, cellophane, water-based polyurethanes, polyester, nylon, high nitrile resins, polyethylene-polyvinyl alcohol copolymer, polystyrene, ethyl cellulose, cellulose acetate, cellulose nitrate, aqueous latexes, polyacrylic acid, polystyrene sulfonate, polyamide, polymethacrylate, polyethylene terephthalate, polystyrene, polyethylene, polypropylene or polyacrylonitrile, or copolymers thereof.

34. The article of claim 28 wherein the barrier layer prevents the diffusion or passage of micro-organisms.

35. A method of removing target metal-ion(s) from an environment comprising contacting the environment with a composition comprising intercalated composite particles comprising a layered host material intercalated with a metal ion sequestrant having a stability constant greater than 10¹⁵ with iron (III), wherein said sequestrant is not an alpha amino carboxylate.

36. The method of claim 35 wherein the environment is a liquid medium.

37. The method of claim 36 wherein the target metal-ion concentration in the liquid medium is reduced to less than 500 ppb.

38. The method of claim 37 wherein the target metal is iron.
